(19) United States
(12) Patent Application Publication
(10) Pub. No.: US 2005/0131715 A1
(43) Pub. Date: Jun. 16, 2005

(54) Method and apparatus for providing location information

(76) Inventor: James R. Trethewey, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/734,853

(22) Filed: Dec. 11, 2003

(51) Int. Cl. G06F 17/60

(52) U.S. Cl. 705/1

(57) ABSTRACT

Approaches for providing location information in conjunction with a web site and/or web page include, for one aspect, automatically providing location information indicating a location of a computing system in response to receiving a web page. For another aspect, location information may be embedded in a web site or web page and provided to a client computing system that may include, for example, a location-enhanced browser.

### CROSS-REFERENCE TO RELATED APPLICATION

The present application is related to co-pending U.S. patent application Ser. No. 10/663,478, entitled, “A Method and Apparatus for Managing the Privacy and Disclosure of Location Information,” Attorney Docket No. 42.P17784, filed Sep. 15, 2003 and assigned to the assignee of the present invention.

### BACKGROUND

An embodiment of the present invention relates to the field of location-based services and, more particularly, to providing location information in connection with a web site and/or web page, for example.

Currently, some web service providers provide location-based services. Examples of currently available location-based services include street maps, driving directions, local weather, restaurant locator services, etc. Typically, to use such location-based services, a user must fill in one or more fields on an associated web page to provide an indication of their current location such as a street address or zip code.

In other cases, organizations or businesses may wish to provide the location of their premises to users such that they can more easily determine a location convenient to them. Currently, there is no standard format for conveying this information.

### BRIEF DESCRIPTION OF THE DRAWINGS

The present invention is illustrated by way of example and not limitation in the figures of the accompanying drawings in which like references indicate similar elements, and in which:

FIG. 1 is a flow diagram showing a method of one embodiment for automatically inputting location information on a web page.

FIG. 2 is a block diagram of an exemplary computing system through which the automatic location information provider of one embodiment may be advantageously implemented.

FIG. 3 is a block diagram showing in more detail, various software and hardware modules that may be provided on the computing system of FIG. 2.

FIG. 4 is a flow diagram showing a method of one embodiment for automatically providing location information to, for example, a web page or web site.

FIG. 5 is a flow diagram showing a method of one embodiment for providing a web page to a computing system that automatically inputs location information.

FIG. 6 is a high-level block diagram of a server that hosts a web site with embedded location information and a client that may access the web site.

FIG. 7 is a flow diagram showing a method of one embodiment for accessing a web site including embedded location information.

FIG. 8 is a flow diagram showing a method of one embodiment for embedding location information in a web site.

### DETAILED DESCRIPTION

A method and apparatus for providing location information in connection with, for example, a web site or web page, are described. In the following description, particular software modules, components, systems, etc. are described for purposes of illustration. It will be appreciated, however, that other embodiments are applicable to other types of software modules, components, and/or systems, for example.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

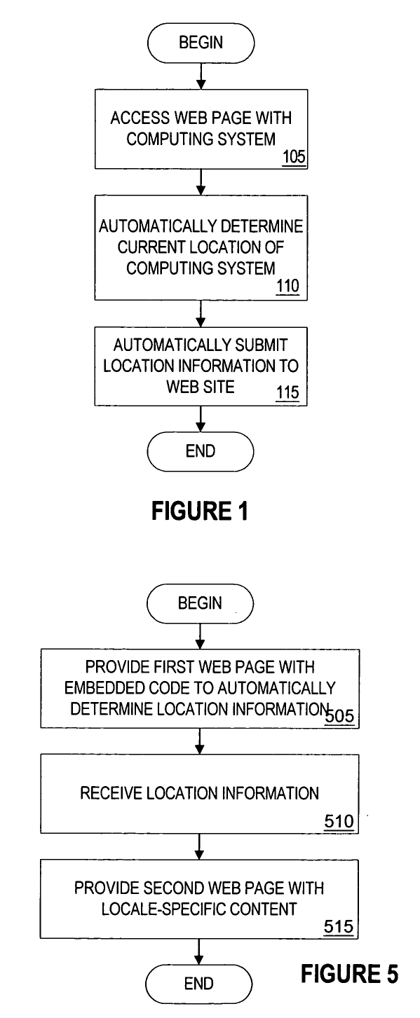

For one embodiment, referring to FIG. 1, a first web page is accessed using a computing system at block 105. At block 110, a current location of the computing system is automatically determined, and at block 115, information indicating the current location of the computing system is automatically submitted to a web site associated with the first web page. Further details of this and other embodiments are provided below.

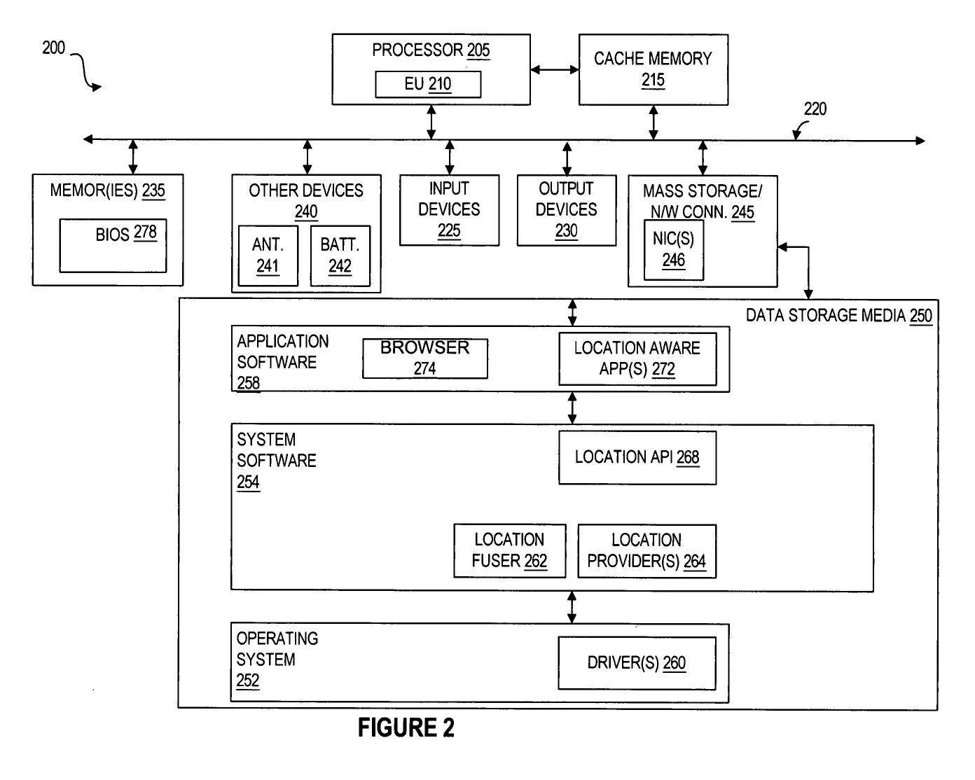

FIG. 2 is a block diagram of an exemplary computing system 200 via which the automatic location information provider approach of one or more embodiments may be advantageously implemented. For one embodiment, the computing system 200 may be a notebook or laptop computer system, for example. Other types of machines, computing and/or computer systems such as cellular phones, personal digital assistants, desktop systems, server systems, etc. are within the scope of various embodiments.

The computing system 200 includes a processor 205 including an execution unit 210 to execute instructions. The processor 205 may be, for example, a Pentium® M microprocessor or other microprocessor available from Intel Corporation of Santa Clara, Calif. Other types of processors, including graphics processors, embedded controllers or processors, digital signal processors, microprocessors from other sources and/or having different architectures, etc. are also within the scope of various embodiments.

A cache memory 215 may be coupled to and/or integrated with the processor 205 to store recently and/or frequently used instructions. The processor 205 may be coupled to a bus 220 to communicate information between the processor 205 and other components in the computer system 200.

Also coupled to the bus 220 are one or more input devices 225, such as a keyboard and/or a cursor control device, one or more output devices 230, such as a monitor and/or printer, one or more memories 235 (e.g. random access memory (RAM), read only memory (ROM), etc.) and other components 240 such as one or more antennae 241, a battery adapter 242 to receive a system battery, a memory controller, graphics controller, and/or a bus bridge, etc. (not shown). One or more mass storage devices and/or other network connectivity devices 245, such as one or more network interface cards (NICs) 246 may also be included. The NICs may act as and/or alternatively be referred to herein as sensors.

The mass storage device(s) and/or network connectivity devices 245 may further include a hard disk drive, a compact disc read only memory (CD ROM) drive and/or an optical disk drive. One or more of the NIC(s) 246 may operate to couple the computer system 200 to one or more other computer systems or mass storage devices over a wired or wireless network, for example. Further, the mass storage device(s) 245 may include additional or alternate mass storage device(s) that may be accessible by the computer system 200 over a network (not shown).

A corresponding data storage medium (or media) 250 (also referred to as a computer-accessible storage medium) may be used to store instructions, data and/or one or more programs to be executed by the processor 205. For one embodiment, the data storage medium (or media) 250 stores information, instructions and/or programs 252-274 that may be used for location-aware computing and/or to provide for automatically providing location information associated with the computing system 200.

For this exemplary embodiment, an operating system 252, system software 254 and application software 258 may be provided.

The operating system of one embodiment may be, for example a Windows™ operating system from Microsoft Corporation of Redmond, Wash. Other types of operating systems such as, for example, a Linux operating system, are within the scope of various embodiments. The operating system 252 may include drivers 260 associated with one or more components of the system 200, such as the NICs (or other sensors) 246.

The system software 254 of one embodiment may include a location fuser 262, one or more location providers 264, and/or a location application programming interface (API) 268. One or more plug-in modules 270 may also be included to provide for specific functionality. Various features and functions of these modules are described in more detail below.

The application software 258 may include, for example, one or more location aware applications 272 and a web browser 274.

Each of the software modules 252, 254 and 258 may include other modules and/or features not shown or described in conjunction with FIG. 2. Further, while a single block is shown to illustrate data storage media 250, multiple mass storage or other storage devices may be used to store the various programs 252-274.

Other computing systems configured in another manner are also within the scope of various embodiments. For example, while only a single bus 220 is shown, it will be appreciated that multiple buses may actually be used to interconnect the various components of the computer system in a different way. A front-side bus may be coupled directly between the processor and one or more chipset components, for example, while a peripheral bus may be coupled between one or more chipset components and one or more peripherals and/or other types of buses.

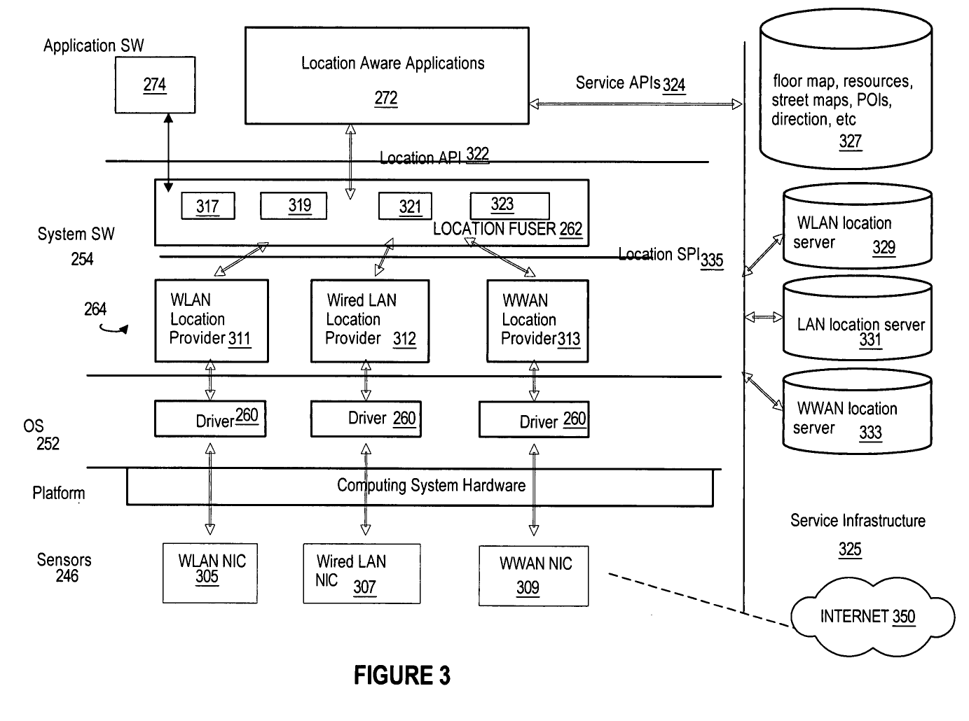

FIG. 3 is a block diagram showing some of the various software and hardware modules of FIG. 2 in more detail. As shown in FIG. 3, the sensors 246 of one embodiment may include one or more of a wireless local area network (WLAN) NIC 305, a wired LAN NIC 307, and/or a wireless wide area network (WWAN) NIC 309 and the drivers 260 and location providers 264 may include drivers 260 and location providers 311-313, respectively, associated with each of the sensors 246 as shown. The location providers 264 (FIG. 2) of one embodiment are location fuser plug-ins to provide standard and/or custom calls to the drivers 260 to get location information via the drivers.

As mentioned above, the system software 254 may also include a module referred to herein as a location fuser 262. Where the operating system 252 is a Windows operating system, the location fuser 262 may be, for example, a windows service. The fuser 262 operates to combine, select and/or derive, through algorithmic and/or mathematical approaches, a reasonable approximation of the computer/user's location based on readings obtained from at least one of the plurality of sensors 246.

The location fuser 262 of one embodiment may include a property provider 317 to transmit location property information, a preferences layer 319 to manage user preferences, a pop-up or other user interface (UI) 321 and scripting capabilities 323 to provide for communication from browser content (e.g. web pages) and other script-based applications, for example. More specifically, the property provider 317 may verify privacy requirements for some embodiments, and, if appropriate, provide the value of the requested location propert(ies) by obtaining them from the fuser 262. The preferences layer 319 provides an interface for various kinds of user interfaces to be plugged in. Additional and/or different modules may be provided as part of the location fuser 262 for various embodiments.

A location service provider interface (SPI) 335 may be provided through which the fuser 262 may communicate with the various location service providers 311-313. One or more location aware applications 272 may communicate with the location fuser and other modules through a location API 322. Service APIs 324 may be included to provide communication between application software 258 and a service infrastructure 325.

Some elements of an exemplary service infrastructure 325 with which the system 200 may interact are shown in FIG. 3. The system 200 may have access via, for example, the Internet or another network, to one or more databases 327 that store information such as floor maps, street maps, directions, etc. The system 200 may also have access to various location servers such as a WLAN location server 329, a LAN location server 331 and/or a WWAN location server 333. Part or all of the service infrastructure 325 including database servers 327, 329, 331 and/or 333 may be physically located in a private network operated by, for example, an enterprise or one of a telecom, WLAN and/or WWAN carrier. Alternatively, part or all of the service infrastructure may be physically located on the public Internet or on a private network on the other side of the Internet (i.e. the public Internet is traversed to reach the database servers on a private network).

As described herein, the computing system 200 including the elements shown in FIGS. 2 and 3 may provide for location-aware computing. When accessing a web site that provides, for example, location-based services, for some embodiments, the computing system 200 may provide for automatic input or submission of location information to the web site. The term location-based services as used herein is broadly defined to include any services that may vary based on location or where different information, such as store location, etc., may be provided based on a given location.

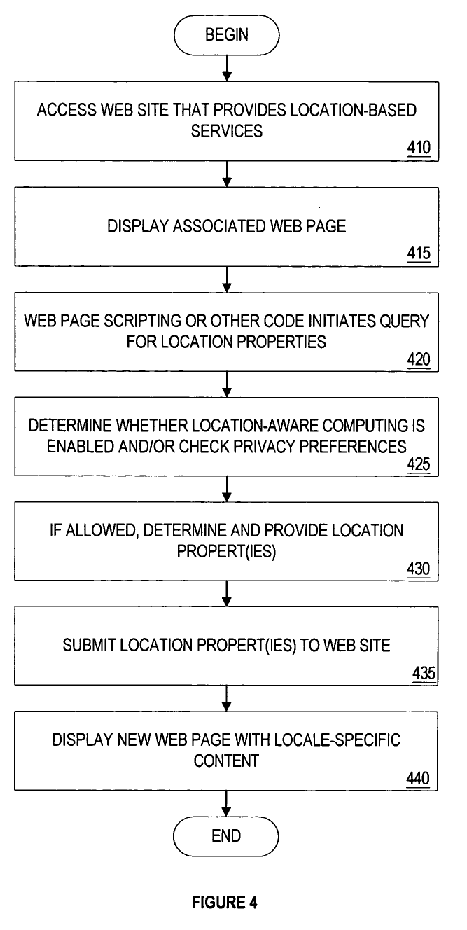

FIG. 4 is a flow diagram showing a method of one embodiment for automatically providing location information to, for example, a web page or web site. In describing the method illustrated in FIG. 4, reference is made to FIGS. 2 and 3 for purposes of illustration. It will be appreciated, however, that the specific hardware and/or software referred to in FIGS. 2 and 3 may not be required to implement the method of FIG. 4 and that other software and/or hardware may be used to implement the methods of various embodiments.

At block 410, a user of, for example, the computing system 200, may access a web site that provides location-based services. The web site may be accessed over the Internet 350 or other network via a network interface, such as, for example, the WWAN NIC 309. While a connection between the WWAN NIC 309 and the Internet 350 is shown in FIG. 3 for purposes of example, it will be appreciated that any of the other NICs or another interface (not shown) may be used to connect the system to the Internet or another network. At block 415, a browser 274 may then display an associated web page which may, for example, be an HTML (HyperText Markup Language) web page.

The web page may include an embedded web page plug-in and scripting for some embodiments. The scripting may be HTML scripting that runs in an HTML browser including, but not limited to ECMAScript in accordance with the ECMAScript specification referred to as ECMA-262 (3rd edition) promulgated by the European Association for Standardizing Information and Communication Systems, formerly known as the European Computer Manufacturer's Association (ECMA). Other scripting languages such as JavaScript from Netscape Corporation of Mountain View, Calif. or JScript from Microsoft Corporation of Redmond, Wash., for example, may alternatively be used.

The scripting may initiate a query at block 420 to extract one or more location properties (e.g. latitude, longitude, altitude, street address, city, state, postal code, etc.) from the property provider 317. For some embodiments, the scripting may make use of the embedded web page plug-in or one or more plug-ins 270 in executing this query. For example, the embedded scripting may make procedure calls to code stored inside a plug-in such that the plug-in effectively serves as a procedure call library. For some embodiments, where a Windows operating system is used, an HTML plug-in may be a Windows DLL that is plugged in to the HTML page by virtue of the HTML <object> tag, which declares the location of the DLL, its Globally Unique Identification (GUID) number, and assigns it a JavaScript (or other type of script) object name. Other approaches for providing similar functionality are within the scope of various embodiments.

At block 425, for some embodiments, it may be determined whether location-aware computing is enabled and/or whether any privacy preferences have been specified as described in copending U.S. patent application Ser. No. 10/663,478, entitled, “A Method and Apparatus for Managing the Privacy and Disclosure of Location Information” referenced above. If location-aware computing is enabled and privacy preferences permit, then, at block 430, a query may be initiated, for example, by the location fuser 262 to return the requested location properties.

For one embodiment, the query by the location fuser 262 is handled by one of the location providers 311-313 to obtain the requested location information from the service infrastructure 325 using sensor readings from the associated driver 260 and NIC 305, 307 and/or 309. More specifically, the location fuser 262 may query one or more of the location providers 311-313 via the SPI 335. In response to this query, each of the location providers may make standard and/or custom procedure calls to respective device drivers 260 to extract sensor readings from NICs 305, 307 and/or 309. While this connection is not explicitly shown in FIG. 3, each of the location providers 311-313 may further query associated location servers 329, 331, and/or 333 directly to find additional location descriptions associated with the sensor readings (i.e. sensor readings may be used as a “lookup key” into the databases on the location servers 329, 331 and/or 333.) Alternatively, for some embodiments, the sensors 246 may take sensor readings from nearby networks without necessarily having to connect with and/or authenticate with those networks. For such embodiments, the NIC 246 may passively snoop information broadcast by the networks.

As described above, the fuser 262 combines, selects or derives a substantially best approximation of the actual computer/user's location using an algorithmic and/or mathematical approach based on sensor readings obtained from device drivers 260 and/or supplemental location descriptions obtained from location servers 329, 331 and/or 333.

It will be appreciated by those of ordinary skill in the art that the fuser 262 may also or alternatively use cached sensor readings or supplemental location descriptions from prior events, rather than executing all of the sequences described above. It will also be appreciated that other approaches for obtaining location information are within the scope of various embodiments.

At block 435, the scripting associated with the web page causes the location properties or other location information to be submitted to the web site by entering the location information into HTML or other fields (e.g text boxes or hidden fields) associated with the web page or directly by submitting either “GET” or “POST” style CGI (Common Gateway Interface) parameters, for example.

At block 440, in response to automatically providing location information as described above, the computing system 200 may then display in the browser 274 a new web page associated with the web site, where the new web page provides locale-specific content. For example, if the web site is a retailer web site, the first-displayed web page may provide general content about the retailer. After automatically providing location information, the second-displayed web page may show retailer locations close to the determined location.

From a server perspective as shown in FIG. 5, a first web page is provided to a client computing system over a network at block 505 in response to the client system accessing a web site hosted by the server. For one embodiment, the first web page includes an embedded web page plug-in and scripting that enables automatic determination of location information.

At block 510, location information associated with a client computing system is received where the location information was automatically provided by the client computing system, at least in part, through executing at least one of the scripting and the plug-in.

At block 515, the web site provides a second web page to the client computing system. The second web page may include locale-specific content based on the location information automatically provided by the client computing system.

Using the approaches of some embodiments for automatically providing location information, it may be possible to improve ease of use of some aspects of computing versus having to enter such data manually.

It will be appreciated that, for various embodiments, the methods described above in reference to FIGS. 4 and 5 may include other actions not shown or described and/or may not include all of the actions shown and/or described.

For certain web sites, as described above, it may be desirable to provide location-related information. For example, retailers, organizations, businesses, etc. may wish to make the locations of their premises available to those who access their web sites. There is currently no standard format for conveying this type of information such that it may be processed automatically by software on a client computing system.

For one embodiment an approach to embedding location information in a web site is provided such that the location information can be conveyed to users' computing systems and processed automatically to, in some cases, provide locale-specific information as described in more detail below.

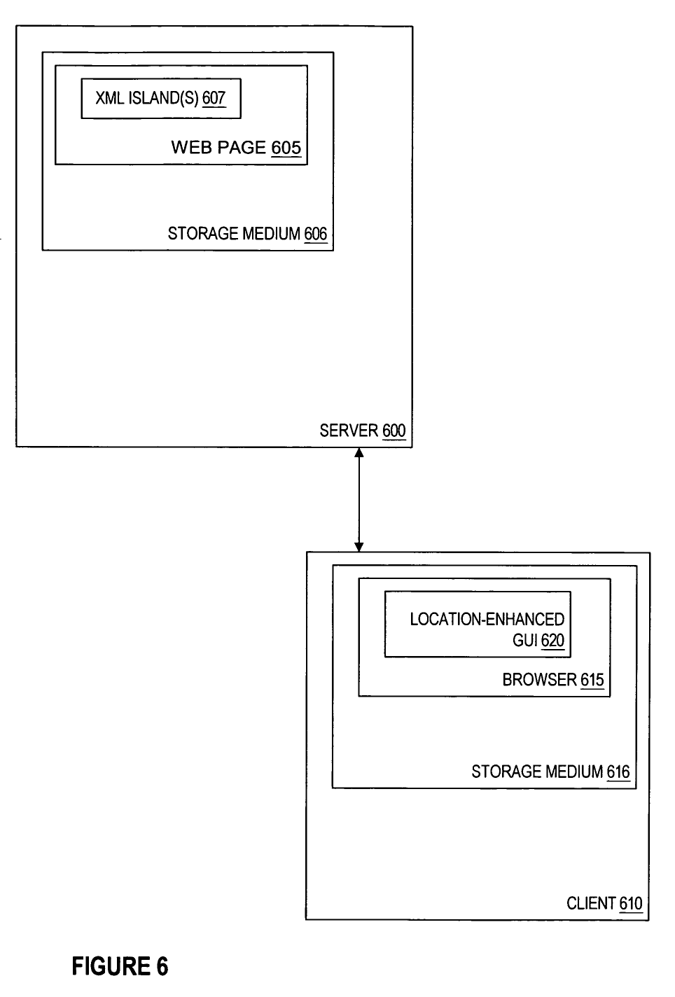

FIG. 6 is a high-level block diagram of a server 600 that hosts a web site. A page 605 associated with the web site may be provided by the server when the web site is accessed by a computing system such as a client computing system 610. For one embodiment, the page 605 is an HTML page. For other embodiments, the page may be provided in a different format. The information to provide the page 605 may be stored on any storage media 606 associated with or accessible by the server 600.

Where the page 605 is an HTML page, the page 605 may be constructed to include embedded XML (Extensible Markup Language) islands 607 that provide location information in a format that may be automatically processed by client software, for example. For one embodiment, a set of XML tags (i.e. a schema) may be defined to provide for any HTML author to embed a description of a location. This XML description may include, but not be limited to latitude, longitude, altitude, street address, city, state, postal code and country, for example. For a retailer, for example, this schema may provide for embedded descriptions of all the stores or sales outlets of a company. Such information may be particularly useful at a web site home page, but may be used for any page.

An example XML location schema that may be used for one or more embodiments to embed location information is provided below with example data. It will be appreciated that a different schema may be used for various embodiments.

```
<?xml version=“1.0” ?>
- <Site id=“Hawthorne Farms”>
-  <AddressInfo>
            <BuildingName>HF3</BuildingName>
            <BuildingFloor>1</BuildingFloor>
            <Street>5200 NE Elam Young Parkway</Street>
            <City>Hillsboro</City>
            <State>Oregon</State>
            <PostalCode>97124</PostalCode>
            <Country>United States</Country>
            <PhoneNumber>1 (503) 696-8080</PhoneNumber>
            <Url>http://www.intel.com</Url>
    </AddressInfo>
- <Position>
            <Latitude>45.531</Latitude>
            <Longitude>−122.930</Longitude>
            <Altitude>48</Altitude>
    </Position>
</Site>
```

XML island example HTML code is provided below for purposes of illustration. It will be appreciated that the code is merely illustrative, that different code may be used for different purposes and/or to implement similar features in a different way and that different location information may be embedded using a similar approach. This particular example code may be embedded to indicate locations of retail dealerships:

```
<html>
    <head>
        <title>Location XML Island Example</title>
    </head>
    <xml id=“dealershipsXmlIsland”>
        <?xml version=“1.0” ?>
        <dealerships>
            <Site id=“Robert Noyce Building”>
                <AddressInfo>
                    <BuildingName>RNB</BuildingName>
                    <BuildingFloor>1</BuildingFloor>
                    <Street>2200 Mission College
Boulevard</Street>
                    <City>Santa Clara</City>
                    <State>California</State>
                    <PostalCode>95054</PostalCode>
                    <Country>United States</Country>
                    <PhoneNumber>1 (408) 765-
8080</PhoneNumber>
                    <Url>http://www.intel.com</Url>
                </AddressInfo>
                <Position>
                    <Latitude>37.387</Latitude>
                    <Longitude>−122.930</Longitude>
                    <Altitude>15</Altitude>
                </Position>
            </Site>
            <Site id=“Hawthorn Farms”>
                <AddressInfo>
                    <BuildingName>HF3</BuildingName>
                    <BuildingFloor>1</BuildingFloor>
                    <Street>5200 NE Elam Young
Parkway</Street>
                    <City>Hillsboro</City>
                    <State>Oregon</State>
                    <PostalCode>97124</PostalCode>
                    <Country>United States</Country>
                    <PhoneNumber>1 (503) 696-
8080</PhoneNumber>
                    <Url>http://www.intel.com</Url>
                </AddressInfo>
                <Position>
                    <Latitude>45.531</Latitude>
                    <Longitude>−121.963</Longitude>
                    <Altitude>48</Altitude>
                </Position>
            </Site>
        </dealerships>
    </xml>
    <script language=“JavaScript”>
        <!--
            function loadXmlIsland ( ) {
                var szNewHtml = “<table border>”;
                // load XML island
                var xmlDoc = dealershipsXmlIsland.XMLDocument;
                // find all the dealership Sites
                xmlDoc.setProperty(“SelectionLanguage”, “XPath”);
                var arrayMatches = xmlDoc.selectNodes(“//Site”);
                // loop through all the sites and create a table on the
fly
                for (i = 0; i < arrayMatches.length; i++) {
                    szNewHtml += “<tr><td>” +
arrayMatches[i].getAttribute(“id”) + “</td></tr>”;
                }
                szNewHtml += “</table>”;
                // jam the new table into the div
                divDealerships.innerHTML = szNewHtml;
            }
        -->
    </script>
    <body onload=“loadXmlIsland( )”>
        Visual elements of HTML page would appear here.
        <hr />
        Names of retailer dealerships:
        <div id=“divDealerships”>
            <!-- Initially empty, JavaScript will fill in here. -->
        </div>
    </body>
</html>
```

Associated visual elements of the HTML page may appear as names of individual sites or retail outlets, for example. For this example, the names of retail dealerships may be displayed while associated location information may be embedded as described.

The client computing system 610, which may be similar in configuration and operation to the computing system 200 of FIG. 2 for some embodiments, may include a browser 615 to access web sites such as the web site hosted by the server 600. The browser 615 may be stored on any storage media 616 associated with or accessible by the client computing system 610. Where the computing system 610 is similar to the computing system 200, the browser 615 may provide similar capabilities to the browser 274. For some embodiments, the browser 615 may be a location-enhanced browser. The location-enhanced browser 615 may be capable of detecting the presence of such XML tags that may not be visible to a conventional browser.

The location-enhanced browser may further include an improved graphical user interface (GUI) 620 for accessing/viewing location information. For example, the GUI 620 may provide a special toolbar or location bar in the browser that provides the ability to view the location information specific to a web site, filter the content by user selection, allow search queries and/or provide other location-based services including, but not limited to, mapping and driving directions. Instead of, or in addition to the location bar, a different type of location-related tool or capability may be provided. Examples include a location applet on the Windows or other operating system System Tray, a location viewer embedded onto the Windows or other Desktop area (e.g. when the Windows Active Desktop feature is enabled), a location tile in a sidebar area, or another location-related feature.

Several different types of capabilities may be provided to filter the location-related content. For example, a filter may be applied to identify from a list of locations the location(s) nearest the computing system or other specified location and possibly sort the locations in order of increasing distance from the location of interest. Other types of filtering may be applied to provide information such as, for example, a shortest route between two points, best detour and/or location with best advertised price, hours of operation, etc nearest to a selected location. It will be appreciated that the examples given above are merely for purposes of illustration and that many other possibilities for providing location-related features and/or applying filters are within the scope of various embodiments.

For some embodiments, where the client computing system includes similar capabilities to the computing system 200 of FIG. 2, the location fuser and/or other hardware/software framework may be used to determine the current location of the client computing system. The location information associated with the client computing system may then be used to filter the location information provided by the XML islands.

Alternatively, instead of having a location-enhanced browser, scripting, such as JavaScript code, may be embedded in the web page to search for such XML tags and interpret them to extract the location information that may not otherwise be visible to a conventional browser. In this manner, a conventional browser can essentially be location-enhanced on the fly. Other approaches for embedding location information using other languages, tags, etc. and for being able to locate and use such information are within the scope of various embodiments.

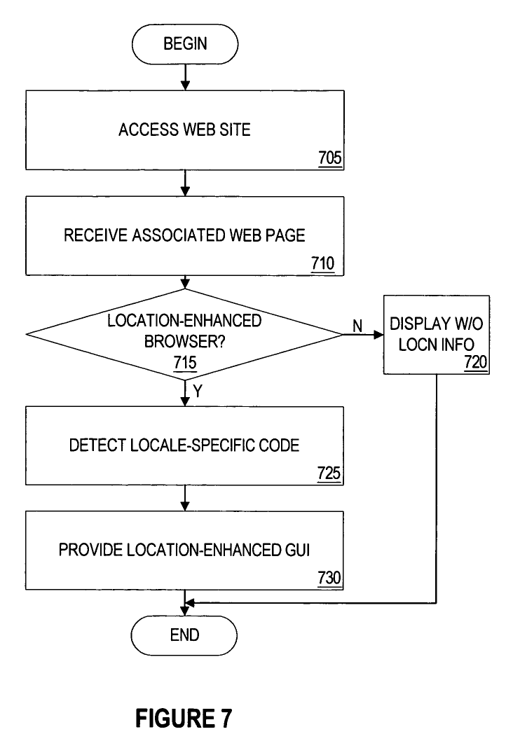

FIG. 7 is a flow diagram showing a method of one embodiment for accessing a web site including embedded location information. For purposes of example, reference may be made to components of the client and server computing systems of FIG. 6 in describing the method of FIG. 7. It will be appreciated, however, that the particular hardware and/or software of FIG. 6 need not be used to practice the method of various embodiments.

At block 705, a web site is accessed and at block 710, an associated web page is received. The associated web page includes embedded XML islands that contain location information such as, for example, retail sales locations associated with the web site. It will be appreciated that other approaches for embedding location information may be used for other embodiments, where embedded location information refers to location information that is not otherwise observed using a conventional view of a conventional browser. At decision block 715, it is determined whether a location enhanced browser or other capability for interpreting XML islands is available. If not, then at block 720, the web page displays in the browser without the information provided by the XML islands.

If a location enhanced browser or other capability for accessing the information provided by the XML islands is provided, then at block 725, the browser or other capability detects the locale-specific XML code. For some embodiments, at block 730, a locale-specific graphical user interface including, for example, a location bar, may then be provided. Additionally, for some embodiments, a current location of a client computing system may be determined and used to filter the location information provided via the XML islands.

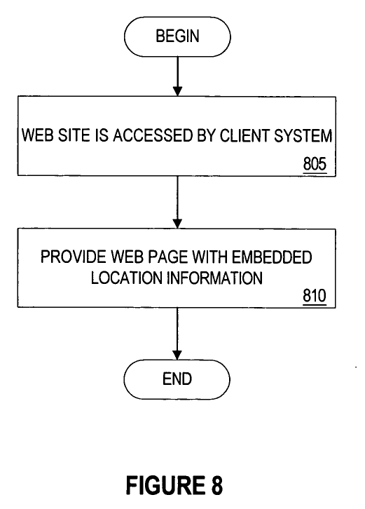

FIG. 8 is a flow diagram showing a method of one embodiment for embedding location information in a web site. At block 805 a web site is accessed by a client computing system. In response to the access, at block 810, the web site provides its web page including embedded XML islands containing location information (e.g. store locations, etc.) or provides embedded location information using a different approach.

It will be appreciated that the methods of FIGS. 7 and 8 may include additional actions not shown or described in reference to FIGS. 7 and 8 and/or some of the actions shown may not be included for some embodiments.

Using the approaches of various embodiments for embedding location information in web sites and/or web pages, and/or receiving web pages with such embedded information, ease of use in working with some location information may be improved. In particular, according to one or more embodiments, an approach to embedding location information is provided such that software on a client computing system may be able to automatically process such location information to provide enhanced usability and/or services.

Thus, various embodiments of a method and apparatus for providing and accessing location information are described. In the foregoing specification, the invention has been described with reference to specific exemplary embodiments thereof. It will, however, be appreciated that various modifications and changes may be made thereto without departing from the broader spirit and scope of the invention as set forth in the appended claims. For example, while the exemplary embodiments described above request location information from external entities in response to a query, for other embodiments, location information may be previously ascertained and stored in an accessible and known location. The specification and drawings are, accordingly, to be regarded in an illustrative rather than a restrictive sense.

1. A method comprising:
accessing a first web page using a computing system;
automatically determining a current location of the computing system; and
automatically submitting information indicating the current location of the computing system to a web site associated with the first web page.

2. The method of claim 1 further comprising:
displaying a second web page associated with the web site, the second web page including locale-specific content associated with the current location of the computing system.

3. The method of claim 1 further comprising:
executing embedded scripting associated with the first web page, the embedded scripting to control, at least in part, automatically determining the current location.

4. The method of claim 3 wherein
executing the embedded scripting includes using plug-in code to assist with automatically determining the current location.

5. The method of claim 3 wherein
executing the embedded scripting includes automatically submitting the information indicating the current location.

6. The method of claim 5 wherein
automatically submitting the information indicating the current location includes automatically determining the information to be submitted according to the embedded scripting.

7. A method comprising:
accessing a web site associated with location-based services using a computing system;
displaying a first web page associated with the web site, the first web page including embedded scripting;
automatically determining a location of the computing system using at least the scripting; and
submitting location information associated with the location of the computing system to the web site.

8. The method of claim 7 further comprising:
displaying a second web page including locale-specific content in response to submitting the location information.

9. The method of claim 7 wherein automatically determining the location of the computing system includes automatically determining at least one of a city, a state, a country, a zip code, and a street.

10. The method of claim 9 wherein automatically determining the location of the computing system includes accessing previously stored location information.

11. The method of claim 9 wherein automatically determining the location of the computing system includes accessing a network to determine the location of the computing system.

12. The method of claim 11 wherein accessing a network includes one of passively snooping the network to determine the location and accessing a database including location information to determine the location.

13. A computer-accessible medium storing information that, when accessed by a computing system, causes the computing system to:
access a first web page including embedded scripting;
execute the embedded scripting; and
automatically determine location information associated with a location of the computing system as a result of executing the scripting.

14. The computer-accessible medium of claim 13 further storing information that, when accessed by a computing system, cause the computing system to
provide the determined location information to a web site associated with the first web page.

15. The computer-accessible medium of claim 14 further storing information that, when accessed by a computing system, cause the computing system to
display a second web page associated with the web site, the second web page including location-specific content responsive to receiving the location information.

16. The computer-accessible medium of claim 13 wherein
executing the embedded scripting includes using an embedded plug-in.

17. The computer-accessible medium of claim 13 wherein
automatically determining the location information includes one of accessing previously stored location information, passively snooping a network to determine the location information and accessing a service infrastructure to determine the location information.

18. A method comprising:
providing a first web page including embedded scripting in response to an access to an associated web site by a computing system, the embedded scripting to cause the computing system to automatically determine and provide location information; and
providing a second web page in response to receiving the location information, the second web page including locale-specific content.

19. The method of claim 18 wherein providing the first web page further includes including one of an embedded plug-in and a call to a plug-in.

20. The method of claim 18 wherein causing the computing system to automatically determine and provide location information includes causing the computing system to automatically determine and provide at least one of a city, a state, a zip code, a country, a latitude, a longitude, a telephone number, and a street address.

21. A method comprising:
receiving a query from a computing system for location information; and
providing the location information to the computing system, the location information being responsive to embedded scripting in a web page accessed by the computing system, the embedded scripting to cause the computing system to automatically determine location information indicated by the scripting.

22. The method of claim 21 wherein providing the location information includes providing at least one of a city, a state, a zip code, a country, a latitude, a longitude, a telephone number and a street address.

23. The method of claim 22 wherein providing the location information is further responsive to a plug-in.

25. A system comprising:
a bus;
a processor including an execution unit coupled to the bus, the processor to execute instructions;
an antenna coupled to the bus to provide for wireless communications; and
a memory to store information that, when executed by the processor, causes the system to
access a first web page including embedded scripting,
automatically determine location information associated with a location of the system in response to executing the scripting, and
display a second web page including locale-specific information in response to determining the location of the system.

26. The system of claim 25 wherein the memory further stores
a location provider, and
a location fuser, the location provider and location fuser to assist in automatically determining the location of the system.

27. The system of claim 26 wherein automatically determining the location of the system includes accessing a service infrastructure in cooperation with the location provider and interpreting information received from the service infrastructure to determine the location information.

28. The system of claim 25 wherein the memory is a mass storage device.

29. The system of claim 25 wherein automatically determining includes one of passively snooping a network, accessing previously stored location information and accessing location information over a network.

30. A method comprising:
receiving a web page with embedded location information; and
accessing the embedded location information using a browser.

31. The method of claim 30 wherein receiving the web page with embedded location information includes receiving the web page with embedded XML islands.

32. The method of claim 30 wherein accessing the embedded location information includes accessing the embedded location information using a location-enhanced browser, the location-enhanced browser to provide a location tool to navigate the embedded location information.

33. The method of claim 32 wherein accessing the embedded location information includes accessing one of address information and driving directions associated with business locations.

34. The method of claim 30 further comprising:
determining a current location of the computing system; and
using a location property associated with the current location to filter the embedded location information.

35. A method comprising:
receiving a web page access from a computing system; and
providing a web page with embedded location information to be displayed by the computing system.

36. The method of claim 35 wherein providing the web page with embedded location information includes providing the web page with location information embedded using XML islands.

37. The method of claim 35 wherein providing the web page with embedded location information includes providing embedded location information indicating business location associated with a business indicated by the web page.

38. A computer-accessible storage medium storing information that, when accessed by a computing system, causes the computing system to:
display a web page including embedded location information; and
display the embedded location information if the computing-system includes a location-enhanced browser.

39. The computer-accessible storage medium of claim 38 further storing information that, when accessed by the computing system, causes the computing system to:
display a location tool to navigate the embedded location information.

40. The computer-accessible storage medium of claim 39 wherein the location tool comprises one of a location bar, a location applet, a location viewer and a location tile.

41. The computer-accessible storage medium of claim 38 further storing information that, when accessed by the computing system, causes the computing system to:
determine a current location of the computing system; and
use a location property associated with the current location to filter the embedded location information.

42. A system comprising:
a bus;
a processor including an execution unit coupled to the bus, the processor to execute instructions;
an antenna coupled to the bus to provide for wireless communications; and
a memory to store information that, when executed by the processor, causes the system to
access a first web page including embedded location information, and
display the embedded location information if the system is running a location-enhanced browser capable of accessing the embedded location information.

43. The system of claim 42 wherein the memory is a mass storage device including one of a hard disk, a network-accessible hard disk, an optical disk, and a compact disc.

44. The system of claim 42 wherein the memory further stores information that, when executed by the processor causes the processor to
determine a location of the system, and
use a location property associated with the location of the system to provide a custom view of the embedded location information.

45. The system of claim 44 wherein
determining a location of the system includes accessing a network via the antenna.

46. The system of claim 42 wherein the memory further stores information that, when accessed by a processor, causes the system to display a location tool bar to navigate the location information.

47. The system of claim 42 wherein the embedded location information is in the form of embedded XML islands.

48. The system of claim 47 wherein, if a location-enhanced browser is not available, the web page displays without the embedded location information.
